(19) United States
(12) Patent Application Publication
(10) Pub. No.: US 2007/0290008 A1
(43) Pub. Date: Dec. 20, 2007

(54) Apparatus for conveying material in a dispensing system

(75) Inventors: Steven L. Becker, Edgerton, WI (US); Dale F. Baumer, Waukesha, WI (US)

Correspondence Address: FOLEY & LARDNER LLP, 777 EAST WISCONSIN AVENUE, MILWAUKEE, WI, 53202-5306, US

(73) Assignee: SCHENCK AccuRate, Inc.

(21) Appl. No.: 11/453,676

(22) Filed: Jun. 15, 2006

(51) Int. Cl. G01F 11/20

(52) U.S. Cl. 222/412

(57) ABSTRACT

An apparatus for conveying material in a dispenser system is disclosed. The apparatus comprises a centerless auger or helix with one or more helical conveying members having a small cross-sectional diameter, a large outer diameter, and a long pitch.

### BACKGROUND

The present invention relates to an apparatus for conveying material in a dispensing system. More specifically, the present invention relates to a dispensing system with a “centerless” auger particularly effective to disperse material at low feed rates.

It is generally known to dispense material at low feed rates. Many low feed rate applications typically require accurate and precise dispensing of material; for example, pharmaceuticals, cosmetics, dietary and nutrition products, chemical compositions, or the like. Such applications typically use batch feeder systems for accuracy and precision. However, such batch systems are slow compared to other types of dispensing systems such as continuous dispensing systems.

Gravimetric, volumetric, and other continuous dispensing systems are also generally known. Such known dispensing systems typically include a hopper and a feeder. Feeders typically include a rotating apparatus that moves material from the hopper to an outlet. These apparatuses are typically referred to as an auger, screw, helix, conveying apparatus, driven conveyer, and will generally be referred to as an auger herein. There are generally two different types of augers. One type is has a solid center structure and a plurality of conveying members (“flights”) extending from the solid center, and appear as threads on a fastener. The other type of known augers is “centerless” and has a plurality of conveying members in the form of blades or rods wound into a helix that provide an “open space” into which material may fall to break up chunks or lumps of material as the auger rotates. These known auger designs typically have a pitch to diameter ratio is typically between 0.5 and 2.0, wherein “pitch” refers to the distance from any point on a flight to the corresponding point on an adjacent flight member measured parallel to the axis of rotation and “diameter” refers to the outer diameter of the flights of the conveying apparatus.

However, such known augers have several disadvantages. For example, typical augers are designed to dispense large amounts of material and not to precisely dispense small amounts of material continuously. Also, when known augers are rotated slowly to provide a low feed rate, pulsations may occur that cause decreased accuracy and consistency. Further, materials having generally high cohesive properties, such as lactose and calcium carbonate powders, tend to flow poorly, bridge or arch over small openings, and stick or clump to itself and/or to the helix. Such “cohesion” decreases the desired performance and the accuracy of the dispensing. The cohesiveness of materials may be due to a variety of factors, including self cohesion, ionic charge, surface tension, size and shape of the particles, roughness or smoothness of the surface of the particles, proportion of the fines present in the material, moisture content, stickiness, abrasiveness, temperature, or the like. For testing and comparison purposes, cohesiveness of materials may be represented by a material property commonly referred to as the “angle of repose.” The “angle of repose” of a material is the angle at which the surface of a normal, freely formed pile makes relative to a horizontal plane. Below is a table based on information provided in the Conveyer Equipment Manufacturers Association (CEMA) Handbook, p. 47, 6^{th} Edition, 2005:

| Angle of | | |
|---|---|---|
| Repose | | |
| (degrees) | Flowability | Examples |
| 0–19 | Very Free Flowing | dry silica sand, |
| | | cement, pellets |
| 20–29 | Free Flowing | whole grains |
| 30–39 | Moderately Flowing | coal, clay, stone |
| 40 up | Sluggish | wood chips |

Materials with an angle of repose of 30 degrees or more is more likely to flow poorly in a dispensing system than a material with an angle of repose of less than 30 degrees. More specifically, following is a list of example materials having an angle of repose of 30 degrees or more:

| Material | Angle of Repose (degrees) |
|---|---|
| Mag. Stearate | 30 |
| Cellulose | 39 |
| Starch | 44 |
| Wheat Protein | 45 |
| Calcium Carbonate | 48 |
| Lactose | 50 |
| Diatomaous Earth | 50 |

When feeding such materials with an angle of repose of 30 degrees or more using a known centerless auger, the material may not fall from the hopper into the open space in the centerless auger if the space and diameter of the opening is too small. Also, such material may not fall out from the discharge chute, but rather bind (e.g., stick, hold, etc.) to the auger. The material may also be discharged in clumps rather than a continuous “stream” of material. Hopper agitation can aid in breaking the bridges over the helix, but cannot solve the problems with the material sticking on the helix or being discharged inconsistently.

Accordingly, it would be advantageous to provide a conveying apparatus that continuously and accurately disperses material having high cohesive properties. To provide an inexpensive, reliable, and widely adaptable dispensing system with a conveying apparatus that avoids the above-referenced and other problems would represent a significant advance in the art.

### SUMMARY

The present invention relates to an apparatus for conveying material in a dispenser system. The apparatus comprises a driven hub; a discharge hub; a first helical conveying member having a first end coupled to the driven hub and a second end coupled to the discharge hub; and a second helical conveying member having a first end coupled to the driven hub and a second end coupled to the discharge hub. The first helical conveying member and the second helical conveying member from an outer diameter and a pitch such that the ratio of the pitch to the outer diameter is at least four.

The present invention also relates to a system for dispensing a material comprising a hopper configured to contain the material; a feeder configured to receive the material from the hopper and comprising: a nozzle having an inlet and an outlet; and a conveying apparatus disposed at least partially in the nozzle. The conveying apparatus having a first conveying member, a second conveying member and one or more discharge members coupled to and extending from the discharge end of the conveying apparatus and extending in the nozzle toward the inlet. The first conveying member and the second conveying member form an outer diameter and a pitch such that the ratio of the pitch to the outer diameter is at least four.

The present invention further relates to a method for dispensing material having an angle of repose of 30 degrees or more at a feed rate of less than 200 grams per hour or material dispensing systems for which it is otherwise desirable to very accurately dispense the material. The method comprising providing a hopper, a nozzle coupled to the hopper, and a centerless helix disposed in the nozzle, the centerless helix having one or more members extending from a discharge end of the centerless helix toward the inlet end of the centerless helix, and two or more conveying members providing a pitch, an outer diameter, and a pitch to outer diameter ratio of more than four. The method further comprises rotating the centerless helix for moving material from the hopper and through the nozzle, thereby providing a first discharge of material from the nozzle per revolution of the centerless helix from the at least one discharge member, and thereby providing a second discharge and a third discharge of material from the nozzle per revolution of the centerless helix from the two or more convey members.

The present invention further relates to various features and combinations of features shown and described in the disclosed embodiments. Other ways in which the objects and features of the disclosed embodiments are accomplished will be described in the following specification or will become apparent to those skilled in the art after they have read this specification. Such other ways are deemed to fall within the scope of the disclosed embodiments if they fall within the scope of the claims which follow.

### BRIEF DESCRIPTION OF THE DRAWINGS

FIG. 1 is a perspective view of a dispensing system according to an exemplary embodiment.

FIG. 2 is a side section view of a dispensing system of FIG. 1.

FIG. 3 is a perspective view of a hopper and feeder for a dispensing system.

FIG. 4 is a perspective section view of the hopper and feeder of FIG. 3.

FIG. 5 is an exploded section view of the hopper and feeder of FIG. 3.

FIG. 6 is a perspective view of an apparatus for conveying material according to an exemplary embodiment.

FIG. 7 is a front elevation view of the apparatus of FIG. 6.

FIG. 8 is a side elevation view of the apparatus of FIG. 6.

FIG. 9 is a front elevation view of apparatus for conveying material according to an alternative embodiment.

FIG. 10 is a top view of an auger according to an exemplary embodiment along with known or conventional augers.

FIG. 11 is a front elevation view of a feeder with a conical discharge chute.

### DETAILED DESCRIPTION OF THE PREFERRED AND EXEMPLARY EMBODIMENTS

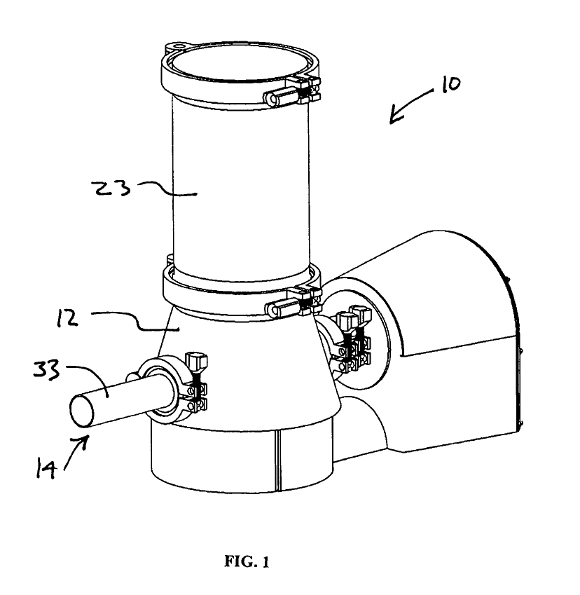

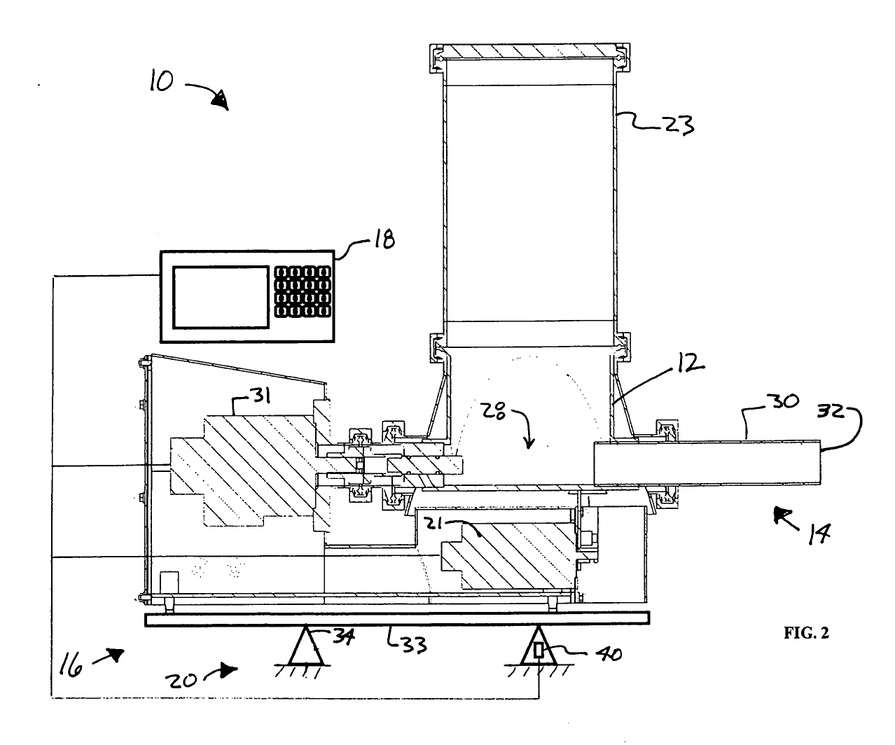

FIGS. 1 and 2 schematically illustrates a dispensing system 10 according to an exemplary embodiment. According to exemplary embodiments, system 10 is advantageous for dispensing or feeding material at a relatively low rate, such as 20 grams of material per hour, continuously, in batches, or the like. Alternatively, system 10 may be configured to dispense at any of a variety of material feed rates.

Referring to FIGS. 1 and 2, system 10 is shown as a volumetric, or a loss-in-weight dispenser and comprises a receptacle or container shown as a hopper 12, a dispenser shown as a feeder 14, a frame shown as a counterbalanced scale 16, a weight measurement system 20, and a controller 18. System 10 is configured to dispense a product or material 22 at a predetermined rate and at a relatively uniform discharge. According to an exemplary embodiment, the material 22 is a separable material (such as particulate, granules, powder, pellets, particles, bits, pieces, or the like). According to a particular embodiment, the material 22 is an ingredient to be mixed with other materials and/or used to manufacture pharmaceuticals, cosmetics, food, and the like.

Hopper 12 contains material 22 that is to be distributed from feeder 14. Hopper 12 may be in communication with a source of material 22 such as an external hopper 23 (e.g., prefeeder, another bin, etc.), that periodically refills or reloads material 22 to hopper 12. To facilitate a continuous and uniform flow of material 22 from hopper 12 into feeder 14, an agitation mechanism or agitator may be provided to aid the flow of material and to condition the material to a constant density. For example, in systems employing flexible hoppers (e.g., vinyl, silicone, rubber, elastomer, etc.), massaging paddles or rods are driven by a motor 21 and are disposed to undulate against the sides of the hopper, agitating the material within it. These high amplitude, relatively low frequency vibrations are intended to condition the material into a uniform bulk density above the metering screw, and tend to prevent arching or bridging of the material across the hopper discharge that inhibits or prevents further flow. Examples of suitable commercially available feeders are AccuRate dry material feeders marketed by the assignee of the present application. In alternative embodiments, the hopper is a rigid structure that may have an internal agitator.

Hopper 12 tapers downwardly and inwardly to form a laterally extending duct or trough 28 at the bottom of hopper 12. The trough 28 is generally cylindrical and top opening and in communication with feeder 14. Feeder 14 receives material 22 flowing from hopper 12. Feeder 14 comprises a driven conveyer (shown as an auger 24) mounted at least partially within a hollow member (e.g., tube, extension piece, hollow cylinder, etc. and generally referred to herein as a passageway or nozzle 30). Auger 24 urges (e.g., feeds, transports, flows, pushes, moves, etc.) material 22 received from hopper 12 through nozzle 30 to a discharge port or outlet 32. Outlet 32 is shown as an opening in nozzle 30 centered on the longitudinal axis of nozzle 30—in other words, the end of nozzle is open. According to alternative embodiments, the discharge outlet may be a slot, aperture, or other opening in the wall of the nozzle (e.g., facing downwardly below the feeder) and the end of the nozzle may be closed. Material 22 existing outlet 32 may be discharged to (or into) packaging or process equipment in which the material is being used or to be further processed, mixed, or the like. According to an exemplary embodiment, the auger and agitation device are driven by one or more electric motors. Alternatively, the motor may be powered by pneumatic, hydraulic or the like. According to alternative embodiments, the hopper, feeder, and auger may have any of a variety of configurations, shapes, sizes, or the like.

Scale 16 is preferably a mechanically counterbalanced flexure type scale, and comprises a frame 33 supported on a pivot or fulcrum. Frame 33 may comprise one or more members such as beams, arms, linkage, or the like. The pivot may be any of a variety of frictionless or friction pivot devices that allow pivoting or counterbalancing of hopper 12.

Controller 18 is configured to receive signals from weight measurement system 20, store data, analyze performance, and generate appropriate control signals to ensure that the weight of material discharged by feeder 14 is maintained in accordance with operator-input parameters or program specifying the desired feed rate/quantity. The controller compares signals representative of the actual feed rate to the set point feed rate and adjusts the speed of the motor 31 to adjust the speed of auger 24. According to an exemplary embodiment, controller 18 comprises a computing device, a display, a user interface, and/or one or more signal converters. The computing device may comprise a computer, a processor, or the like. The user interface may be a keyboard, keypad, or the like. The signal converters may be analog to digital converters, digital to analog converters, or the like. Controller 18 is shown schematically coupled (in communication with) motor 31, motor 21, and load cell 40 in FIG. 2.

According to an exemplary embodiment, weight measurement system 20 is configured to measure or detect the weight of material 22 being dispensed by feeder 14. Weight measurement system 20 comprises one or more sensors (e.g., a load cell, strain gauge, transducer, or the like, and shown generally schematically as load cell 40). In the schematically illustrated embodiment, scale 16 is counterbalanced by a counterbalance force, preferably provided by a “dead” weight load, to counterbalance or offset the weight of hopper 12, so that the sensor output signal is representative of the weight of material 22 in hopper 12. As such, output of the sensor is thus zeroed to the tare weight of hopper 12. Control is effected in accordance with differences in the weight, rather than absolute weight, and non-zero signals indicative of the tare weights may thus be accommodated. The dead weight may be provided by any of a variety of weighted structures, such as functional devices and non-functional “dead” weight, that offsets or balances the weight of the material in hopper 12. The description of a gravimetric dispenser is illustrative only; according to alternative embodiments, the dispensing system may be any of a variety of dispensing systems, including volumetric, continuous, or the like.

According to a preferred embodiment, auger 24 is particularly advantageously used to accurately and precisely convey material, particularly material having high cohesive properties (e.g., an angle of repose of 30 degrees or more), at relatively low feed rates, although the auger may be used to feed a wide variety of materials. Examples of such materials include calcium carbonate, lactose, magnesium stearate, cellulose, starch, wheat protein, or diatomaous earth, or the like. Possible applications for such dispensing include, for example, ingredients in pharmaceuticals, chemical compositions, or biological or dietary applications. An auger, as described herein, “inefficiently” moves the material by being “centerless” and having a relatively large diameter helix made from conveying members with relatively small cross-sectional dimensions and rotated at a relatively high revolution speed compared to prior art augers or metering screws that have been typically used for such applications. Such a configuration allows the material to be slowly moved toward the discharge outlet and to tumble upon itself and upon the conveying members through the open space in the center of the centerless auger 24.

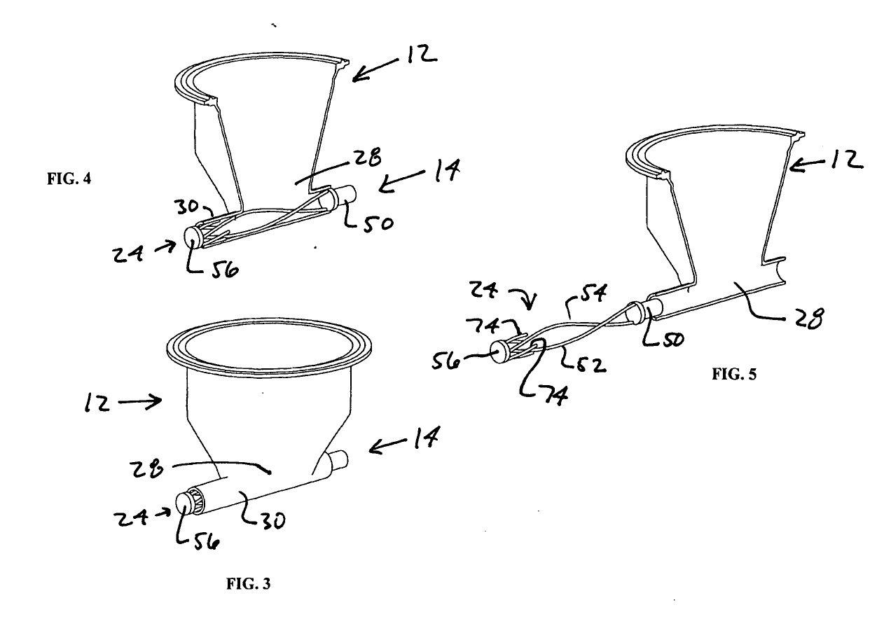

Referring to FIG. 3-8, an exemplary embodiment of auger 24 is shown. Auger 24 is disposed longitudinally within trough 28 and nozzle 30, and comprises a driven hub 50, two conveying members 52, 54, and a discharge hub 56. Auger 24 is configured to move material 22 from hopper 12 toward discharge outlet 32 by rotation of the one or more helical conveying members 52, 54. The auger 24 is “centerless,” i.e., does not have structure inside of the one or more conveying members 52, 54 (e.g., to support the conveying members 52, 54) so that material 22 can turn, tumble, fall, drop, or the like as it is being transferred toward discharge outlet 32. According to an exemplary embodiment, auger 24 may be usefully configured to dispense material at a feed rate of less than 200 grams per hour. According to a preferred embodiment, the auger 24 dispenses material at a feed rate at between 20 grams per hour and 100 grams per hour. According to an alternative embodiment, the auger surrounds a conventional or commercially available screw.

Driven hub 50 (e.g., base, quill, etc.) is coupled to a motor 41 and is configured to transfer rotation to the one or more conveying members 52, 54. Driven hub 50 may be coupled to or supported by a bearing in trough 28 and/or nozzle 30 to help maintain an axial alignment of auger 24 within nozzle 30 and reduce friction against rotation of auger 24. The rotation of auger 24 is preferably at a relatively high rate, e.g., revolutions per minute (rpm), compared to rotational speeds that have previously been used for materials with an angle of repose of 30 degrees or more, or for feed rates of less than 200 grams per hour. For example, auger 24 is rotated at higher revolutions than conventional augers of the same outer diameter for the same type of application. The relatively higher rotation speed of auger 24 reduces the pulsations that tend to occur when known screws are rotated slowly to provide low feed rates. According to an exemplary embodiment, auger 24 is rotated at least 1 rpm, particularly for material that has an angle of repose of 30 degrees or more. According to a preferred embodiment, auger 24 is rotated between about 3 rpm and about 200 rpm for such materials. The higher revolution speed of the auger 24 reduces the pulsations normally seen with slow turning helixes used for low rates. According to alternative embodiments, other rotational speeds by be used that provide the desired material handling.

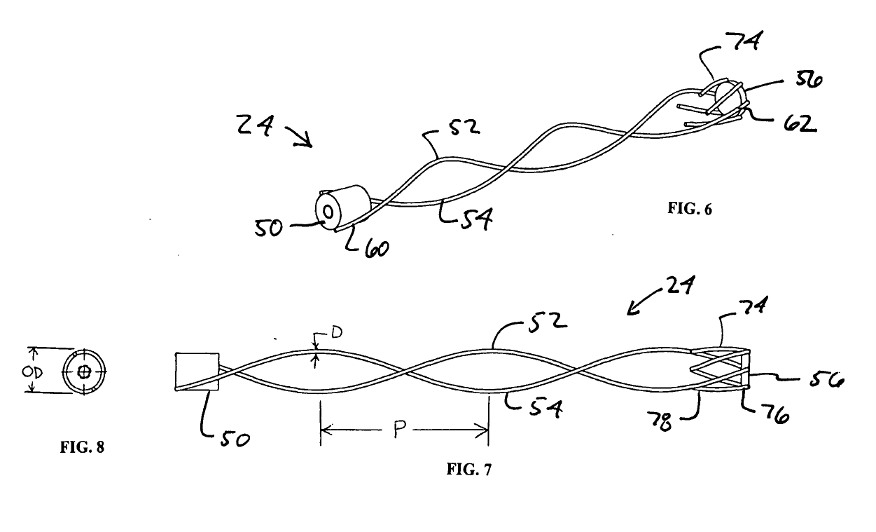

The one or more conveying members 52, 54 (e.g., rods, flights, blades, etc.) are configured to engage and urge material 22 from hopper 12 toward discharge outlet 32. As shown in FIGS. 6 and 7, auger 24 preferably comprises two conveying members 52, 54, but may comprise only one conveying member 52 or 54. According to exemplary embodiments, there may be one, three, four, or more conveying members depending on the desired feed rate performance, size of the dispensing system, size of the material being dispensed, or the like.

Each one or more conveying member 52, 54 includes a first end 60 coupled (e.g., fastened, welded, etc.) to driven hub 50 and a second end 62 coupled (e.g., fastened, welded, etc.) to discharge hub 56. The one or more conveying members 52, 54 are preferably rods with a circular cross-section that have been formed into or provided a helical curvature. The one or more conveying members 52 or 54 have or provide an outer circumference or diameter OD. The size of the outer diameter OD is intended to allow material 22 to fall from conveying member 52, 54 more easily. According to exemplary embodiments, the one or more conveying members 52, 54 provide a uniform outer diameter OD of at least ½ inch for materials with an angle of repose of 30 degrees or more. According to a preferred embodiment, the outer diameter OD is between about ¾ inch and about 2¼ inches for such materials. The larger diameter allows material to fall into the one or more conveying members more easily and the small surface presented to the material is less likely to bind or stick to the one or more conveying members. According to exemplary embodiments, the outer diameter may be any of a variety of dimensions depending on the desired feed rate performance, size of the dispensing system, size of the material being dispensed, or the like.

According to an exemplary embodiment, the outer surface of the one or more conveying members 52, 54 contact the inner wall surface of nozzle 30 so that material is not trapped between the one or more conveying members 52, 54 and nozzle 30, i.e., scrapes the wall 70 of nozzle 30. According to a preferred embodiment, the outside diameter OD of the conveying members 52, 54 is slightly smaller than the inside diameter ID of the nozzle 30 to provide a gap or space between the conveying members and the wall of the nozzle (e.g., a clearance fit). According to a particularly preferred embodiment, the gap between the conveying members and the wall of the nozzle is approximately 0.060 inches on the radius (i.e., approximately 0.120 inch difference between the outside diameter OD of the conveying members 52, 54 is slightly smaller than the inside diameter ID of the nozzle 30). According to an alternative embodiment, the outer diameter OD of the one or more conveying members 52, 54 (measured before being mounted within nozzle 30) is slightly larger than the inside diameter ID of nozzle 30 (e.g., an interference or force fit). As such, the one or more conveying members 52, 54 are in a biased condition when mounted in nozzle 30 and are ensured to be in contact with the wall 70 of nozzle 30.

Each conveying member 52, 54 have a cross-sectional dimension D; for example, a diameter or gauge when the one or more conveying members are made from wire or rods with a circular cross-section. The cross-sectional dimension D of the one or more conveying members 52, 54 is relatively small compared to the dimension or size of flights that would typically be used for conveying material with an angle of repose of 30 degrees or more at low feed rates. The relatively small cross-sectional dimension D of the one or more conveying members 52, 54 is intended to provide or present a smaller surface area that engages material 22 so that less material is conveyed and the material is less likely to bind or stick to the one or more conveying members 52, 54. According to exemplary embodiments, the diameter D of the wire used for the one or more conveying members is more than 1/32 inch for material with an angle of repose of 30 degrees or more. According to a preferred embodiment, the diameter is between about 1/16 inch and about ¼ inch for such materials. Preferably but not necessary, the conveying members 52, 54 have the same cross-sectional dimension. According to alternative embodiments, the cross-sectional dimension of one or both of the conveying members 52, 54 may be any of a variety of dimensions configured to provide the desired material handling.

Referring to FIG. 7, pitch “P” of the one or more conveying members 52, 54 refers to the distance from any point on a conveying member to the corresponding point on an adjacent conveying member 52, 54 measured parallel to the axis of rotation. Compared to known augers, pitch P of the one or more conveying members 52, 54 on auger 24 is substantially larger. For comparison purposes for a variety of applications, a ratio of the pitch P to the diameter OD (i.e., pitch/diameter or P/OD) may be used. For example, the pitch/diameter ratio on known screws is less than four (4) (i.e., pitch/diameter). According to an exemplary embodiment, the pitch/diameter ratio on auger 24 is uniform and greater than about four (4). According to a preferred embodiment, the pitch/diameter ratio on auger 24 is between about four (4) and about ten (10). According to exemplary embodiments, the pitch P may be any of a variety of dimensions, and may vary, depending on the desired feed rate performance, size of the dispensing system, size of the material being dispensed, or the like.

Discharge hub 56 is configured to provide structural support for conveying members 52 and/or 54. Discharge hub 56 may be coupled to nozzle 30 by a bearing to help maintain axial alignment of auger 24 within nozzle 30 and reduce friction against rotation of auger 24.

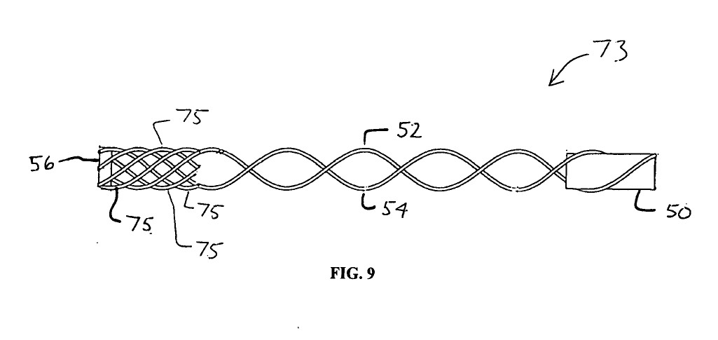

According to an exemplary embodiment, one or more supplemental discharge members 74 is coupled to discharge hub 56 and is configured to stir or agitate material prior to or assist the material as it is being discharged, to reduce pulsations that normally occurs with slow moving screws that are used for low feed rates, and to generally create a more uniform material flow. The one or more discharge members 74 are also configured to provide for additional discharges of material per revolution than conventional screws without discharge members 74 extending from discharge hubs 56. Each discharge member 74 provides for an additional discharge per revolution. For example, two discharge members 74 provide for two additional discharges per revolution. The additional discharges are intended to provide improved discharge constancy (i.e., more constant discharge) at the same rotational speed. Referring to FIG. 7, discharge hub 56 comprises four discharge members 74 each of which comprise a first end 76 coupled to discharge hub 56 and a second end 78 that extends toward trough 28. FIG. 9 shows an auger 73 with discharge members 75 according to an alternative embodiment. Auger 73 comprises four discharge members 75 coupled to discharge hub 56. Discharge members 75 are similar to discharge members 74 except that discharge members 75 have a different curvature and orientation than discharge members 74. As such, auger 73 shown in FIG. 9 provides six (6) discharges per revolution of auger 73. Discharge members may be curved (e.g., helical) or straight, and may be inside or outside the diameter of the one or more conveying members.

In operation, the motor 41 rotates auger 24 by a rotational force applied to driven hub 50. Rotation of auger 24 causes material 22 being received from hopper 12 and falling into trough 28 to be driven (e.g., moved, transferred, urged, etc.) from the trough 28 through nozzle 30, and out discharge outlet 32. The one or more conveying members 52, 54 present a large diameter OD in the throat of trough 28 to agitate and move material horizontally. The relatively large pitch P and relatively small cross-sectional dimension D of the one or more conveying members 52, 54 pushes a small amount of material 22 through nozzle 30. The relatively large pitch P and relatively small cross-sectional dimension of the conveying members 52, 54 moves material in partially filled nozzle 30 to the discharge outlet 32.

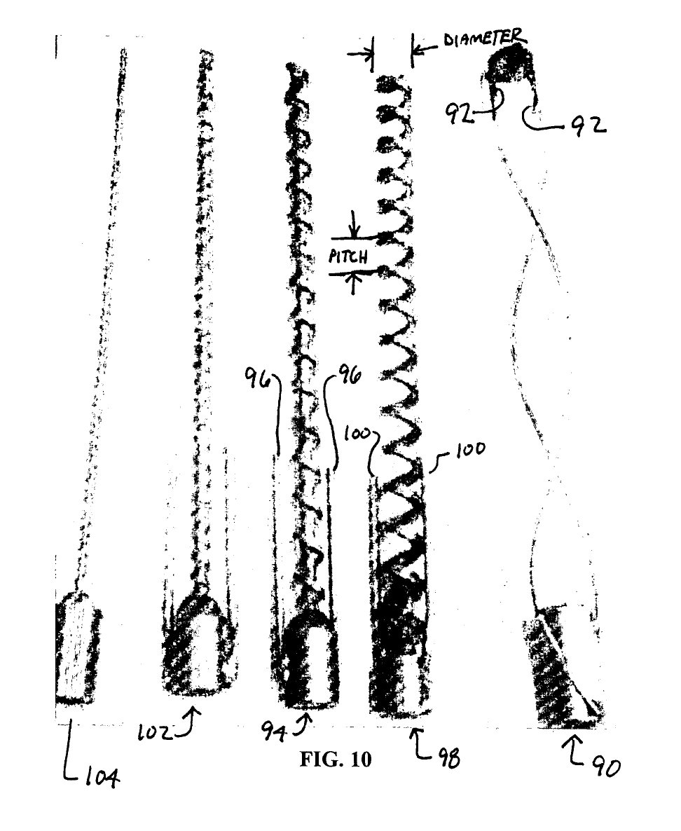

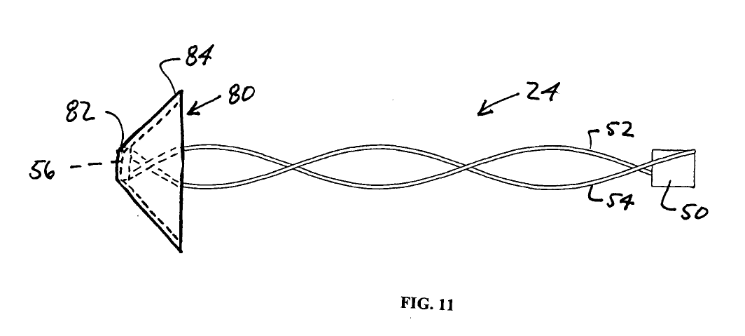

A test has been conducted to compare the feed rate and accuracy of an auger according to an exemplary embodiment to two conventional or known augers. The conveying apparatuses used for the test are shown in FIG. 10. The augers used for the test were:
a. an auger according to an exemplary embodiment (which will be referred to as the “exemplary centerless helix” and reference number 90 in FIG. 10), which had a 1.6 millimeter (mm) wire wound in a helix at a pitch of 150 mm, included two discharge stirring rods or members 92, and was mounted in a stainless steel nozzle having a 19 millimeter (mm) inside diameter. The ratio of the pitch to the outside diameter for the exemplary centerless helix 90 is approximately 7.9.
b. a “conventional” or “known” solid screw (which will be referred to as the “known solid screw” and reference number 94 in FIG. 10), which had a ⅜ inch outer diameter and a ⅜ inch pitch, had a solid interior structure, two front stirring rods 96, and was mounted in a polymer nozzle having a ⅜ inch (0.375 inch) inside diameter. The ratio of the pitch to the outside diameter for the known solid screw 94 is approximately 1.0.
c. a “conventional” or “known” centerless helix (which will be referred to as the “known centerless helix” and reference number 98 in FIG. 10), which had a ½ inch outer diameter and a ½ inch pitch (i.e., pitch=½ diameter) open flight, wound square wire with two stirring rods 100, and was mounted in a polymer nozzle having a ½ inch inside diameter. The ratio of the pitch to the outside diameter for the known centerless helix 98 is approximately 1.0.
   FIG. 10 also shows a “conventional” or “known” solid screw 102 having a ¼ inch outer diameter, ¼ inch pitch, and two stirring rods extending from the driven hub. FIG. 10 further shows a “conventional” or “known” solid screw 104 having a ⅛inch outer diameter, ⅛ inch pitch. However, neither the known ¼ solid screw 102 nor the ⅛ inch solid screw 104 would feed the material in this attempt—the material bound or adhered to the screws 102, 104. The material used for all tests was calcium carbonate, which has an angle of repose of 48 degrees according to the Conveyer Equipment Manufacturers Association (CEMA) Handbook, p. 46, 6^{th} Edition, 2005. Samples were taken every 60 seconds; thirty samples were taken and the mean calculated and is shown in Table 1 below. The data and graphs support the improved performance and advantages stated herein.

TABLE 1
Exemplary Centerless Helix (19 mm)

| | | Feedrate | Feedrate | | | 2 Std | |
|---|---|---|---|---|---|---|---|
| | | Mean | Mean | 1 Std | 1 Std | Dev | |
| RPM | Pot | g/min* | kg/hr* | Dev | Dev % | % | g/hr |
| 1.47 | 5 | 0.3157 | 0.0189 | 0.0304 | 9.63 | 19.26 | 18.94 |
| 2.37 | 10 | 0.4572 | 0.0274 | 0.0217 | 4.75 | 9.50 | 27.43 |
| 4.17 | 20 | 0.8001 | 0.0480 | 0.0166 | 2.07 | 4.14 | 48.01 |
| 5.80 | 30 | 1.1110 | 0.0667 | 0.0421 | 3.78 | 7.56 | 66.66 |
| 9.47 | 50 | 1.7766 | 0.1066 | 0.0656 | 3.69 | 7.38 | 106.60 |
| 13.50 | 75 | 2.7862 | 0.1672 | 0.0679 | 2.44 | 4.88 | 167.17 |
| 18.00 | 100 | 3.7890 | 0.2273 | 0.1026 | 2.71 | 5.41 | 227.34 |

TABLE 2
Known Solid Screw (9.5 mm)

| | | Feedrate | Feedrate | | 1 Std | | |
|---|---|---|---|---|---|---|---|
| | | Mean | Mean | | Dev | 2 Std | |
| RPM | Pot | g/min* | kg/hr* | 1 Std Dev | % | Dev % | g/hr |
| 18.00 | 100 | 0.3258 | 0.0195 | 0.0585 | 17.95 | 35.89 | 19.55 |
| 27.00 | 150 | 0.3860 | 0.0232 | 0.0624 | 16.17 | 32.34 | 23.16 |
| 35.00 | 200 | 0.6063 | 0.0364 | 0.085 | 14.02 | 28.03 | 36.38 |
| 53.00 | 300 | 0.8367 | 0.0502 | 0.089 | 10.64 | 21.27 | 50.20 |
| 74.00 | 400 | 1.3906 | 0.0834 | 0.1764 | 12.69 | 25.38 | 83.44 |
| 95.00 | 500 | 1.5950 | 0.0957 | 0.1909 | 11.97 | 23.94 | 95.70 |

TABLE 3
Known Centerless Helix (13 mm)

| | | Feedrate | Feedrate | | | 2 Std | |
|---|---|---|---|---|---|---|---|
| | | Mean | Mean | 1 Std | 1 Std | Dev | |
| RPM | Pot | g/min* | kg/hr* | Dev | Dev % | % | g/hr |
| 2.00 | 11 | 0.4248 | 0.0255 | 0.0361 | 8.49 | 16.99 | 25.49 |
| 5.30 | 30 | 0.9638 | 0.0578 | 0.067 | 6.95 | 13.90 | 57.83 |
| 9.00 | 50 | 2.0957 | 0.1257 | 0.1425 | 6.80 | 13.60 | 125.74 |
| 17.50 | 100 | 3.7944 | 0.2277 | 0.1453 | 3.83 | 7.66 | 227.66 |

The test results indicate that feed rates can be attained for a low feed rate application (e.g., around 20 grams per hour or g/hr) using the exemplary centerless helix 90 and with a known centerless helix 98. However, the larger diameter of the exemplary centerless helix 90 allowed the material to more easily fall into the trough at the bottom of the hopper, allowed for a more total clean out of the hopper since stirring rods are not needed. Stirring rods are intended to increase the effective trough diameter to ¾ inch on the exemplary centerless helix that provides for a “dead space” for material to build up and provide a more gentle agitation of the material.

Performance accuracy is preferably calculated as two standard of deviations (percentage) of the mean feed rate. The lower the standard of deviation, the more accurate the dispensing. The graphs below are based on the data above and are intended to illustrate the improvement in performance of the exemplary auger. The exemplary auger provides better accuracy, less deviation, and more consistent material dispensing. The conventional screw provides one discharge of material per revolution, which results in accuracy that is quite poor. The exemplary centerless helix 90 with discharge members 92 allow for four pulses per revolution, which results in improved discharge constancy.

Additionally, the build-up on the exemplary auger was minimal compared to the known conveying apparatuses. The build-up on the conventional screw was noticeable and substantially more than the exemplary centerless helix. Below are charts illustrating the test data for the exemplary auger according to an exemplary embodiment compared to performance of a conventional screw.

According to an exemplary embodiment shown in FIG. 11, a discharge chute or guide 80 is located at discharge outlet 32 and is configured to direct the material being discharged to a desired direction. Discharge chute 80 may be coupled to nozzle 30, discharge hub 56, or another part of dispenser system 10. According to a preferred embodiment, discharge chute 80 is coupled to discharge hub 56 and is conical shaped with its smaller end 82 coupled to discharge hub 56 and its larger end 84 extending back towards driven hub 50 so that material urged out of discharge outlet 32 falls onto rotating, conically shaped discharge chute 80. Rotating discharge chute 80 causes material to rotate until gravity breaks any cohesion with the wall of discharge chute and it tumbles or falls down on another portion of discharge chute 80. Such tumbling material then eventually falls from discharge chute 80 to the desired place.

While the components of the disclosed embodiments will be illustrated as a loss-in-weight dispensing system, the features of the disclosed embodiments have a much wider applicability. For example, long-pitch centerless helix design is adaptable for other dispensing systems. Further, the size of the various components and the size of the containers can be widely varied. Also, one or more stirring members or rods, such as those shown in FIG. 10 on the conventional augers, may be coupled to driven hub 50 and are configured to stir or agitate material 22 in trough 28 and/or nozzle 30. The stirring rods comprise a first end coupled to driven hub 50 and a second end that extends toward discharge end. The stirring rods may extend curved (e.g., helical) or straight from driven hub 50, and may be inside or outside the diameter the diameter of the one or more conveying members 52, 54.

Also, the particular materials or products that may be dispensed are also illustrative. For example, the dispensing system may be used for any of a variety of dispensed products, including liquid, fine powder, or larger bulk solid.

Further, it is important to note that the term “hopper,” “feeder,” “helix,” and “conveying members” are intended to be broad terms and not terms of limitation. These components may be used with any of a variety of products or arrangements and are not intended to be limited to use with loss-in-weight dispensing applications.

It is also important to note that the construction and arrangement of the elements of the long pitch auger as shown in the preferred and other exemplary embodiments are illustrative only. Although only a few embodiments of the present invention have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the claims. Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and/or omissions may be made in the design, operating conditions and arrangement of the preferred and other exemplary embodiments without departing from the spirit of the present invention as expressed in the appended claims.

What is claimed:

1. An apparatus for conveying material in a dispenser system, the apparatus comprising:
a driven hub;
a first helical conveying member having a first end coupled to the driven hub;
wherein the first helical conveying member forms an outer diameter and a pitch such that the ratio of the pitch to the outer diameter is at least four.

2. The apparatus of claim 1 wherein the ratio of the pitch to the outer diameter is between about four and about ten.

3. The apparatus of claim 1 wherein the pitch is uniform along the entire length of the first helical conveying member.

4. The apparatus of claim 1 further comprising a second helical conveying member having a first end coupled to the driven hub.

5. The apparatus of claim 4 wherein the first helical conveying member and the second helical conveying member provide two discharges of material per revolution of the apparatus.

6. The apparatus of claim 5 further comprising a discharge hub wherein the first helical conveying member comprises a second end coupled to the discharge hub, and the second helical conveying member comprises a second end coupled to the discharge hub.

7. The apparatus of claim 6 further comprising one or more discharge members having a first end coupled to the discharge hub and a second end extending toward the driven hub and engage the material and provide additional discharges of the material per revolution of the apparatus.

8. The apparatus of claim 1 further comprising one or more members having a first end coupled to the driven hub and a second end extending towards the discharge hub.

9. The apparatus of claim 1 wherein the first helical conveying member and the second helical conveying member are rods with a circular cross-section.

10. The apparatus of claim 9 wherein the rods have a cross-sectional diameter of less than ¼ inch.

11. A system for dispensing a material comprising:
a hopper configured to contain the material;
a feeder configured to receive the material from the hopper and comprising:
a nozzle having an inlet in communication with the hopper and a discharge outlet; and
a conveying apparatus disposed at least partially in the nozzle and having a first conveying member, a second conveying member and one or more discharge members coupled to and extending from the discharge end of the conveying apparatus and extending in the nozzle toward the inlet.

12. The system of claim 11 wherein the first conveying member and the second conveying member form an outer diameter and a pitch such that the ratio of the pitch to the outer diameter is at least four.

13. The system of claim 11 wherein the first conveying member and the second conveying member form an outer diameter and the nozzle comprises an inside diameter greater than the outer diameter of the first conveying member and the second conveying member.

14. The system of claim 11 wherein the first helical conveying member and the second helical conveying member contact the inner wall of the nozzle.

15. The system of claim 14 wherein the first helical conveying member and the second helical conveying member are in a biased condition when mounted in the nozzle.

16. The system of claim 15 wherein the nozzle includes an inner diameter that is smaller than the outer diameter of the first conveying member and the second conveying member.

17. The system of claim 11 wherein the ratio of the pitch to the outer diameter is between about four and about ten.

18. The system of claim 11 further comprising a discharge chute located at the discharge outlet of the nozzle and configured to guide the discharged material at least partially toward the driven hub.

19. The system of claim 18 wherein the discharge chute is conically shaped and comprises a smaller diameter end coupled to the discharge hub and a larger diameter end extending toward the driven hub.

20. The system of claim 19 wherein the conical chute is coupled to the discharge end of the conveying apparatus.

21. The system of claim 11 wherein the one or more discharge members comprises a first discharge member and a second discharge member, each discharge member having a first end coupled to the discharge hub and a second end extending toward the driven hub and are configured to engage the material and provide two additional discharges of the material per revolution of the conveying apparatus.

22. A method for dispensing material having an angle of repose of 30 degrees or more at a feed rate of less than 200 grams per hour, the method comprising:
providing a hopper, a nozzle coupled to the hopper, and a centerless helix disposed in the nozzle, the centerless helix having one or more members extending from a discharge end of the centerless helix toward the inlet end of the centerless helix, and two or more conveying members providing a pitch, an outer diameter, and a pitch to outer diameter ratio of more than four;
rotating the centerless helix and moving material from the hopper and through the nozzle;
providing a first discharge of material from the nozzle per revolution of the centerless helix from the at least one discharge member;
providing a second discharge and a third discharge of material from the nozzle per revolution of the centerless helix from the two or more convey members.

23. The method of claim 22 wherein the step of rotating the centerless helix comprises rotating the centerless helix between about 1 rpm and about 200 rpm.

24. The method of claim 22 further comprising dispensing the material onto a conical dispensing chute coupled to the centerless helix.
